(19) United States
(12) Patent Application Publication
(10) Pub. No.: US 2026/0028041 A1
(43) Pub. Date: Jan. 29, 2026

(54) Method for Fusing Grid Maps Obtained Based on Multi-Sensors and Mobility Device Using the Method

(71) Applicants: Hyundai Motor Company, Seoul (KR); Kia Corporation, Seoul (KR); Kookmin University Industry Academy Cooperation Foundation, Seoul (KR)

(72) Inventors: Se Jong Heo, Hwaseong-Si (KR); Kyung Jae Ahn, Seongnam-Si (KR); Ha Rin Jang, Seoul (KR); Tae Hyun Kim, Seoul (KR); Jong Jin Won, Seoul (KR); Yeon Sik Kang, Seoul (KR); Jin Woo Kim, Seoul (KR)

(21) Appl. No.: 19/037,733

(22) Filed: Jan. 27, 2025

(30) Foreign Application Priority Data
Jul. 26, 2024 (KR) 10-2024-0099526

(51) Int. Cl. B60W 60/00; G06V 10/80; G06V 20/58; G06V 20/70

(52) U.S. Cl. CPC B60W 60/001; G06V 10/80; G06V 20/58; G06V 20/70

(57) ABSTRACT

A method performed by an apparatus for controlling autonomous driving of a vehicle is introduced. The method may comprise generating, based on a segmentation model processing point cloud data, a first semantic grid map, generating, based on an object detection model, a second semantic grid map, adjusting a probability regarding whether occupancy exists for an element included in each grid of the first semantic grid map and the second semantic grid map, and generating a fused grid map by determining, as a representative label, at least one label corresponding to a highest value among final probabilities of the at least one label, wherein the final probabilities are determined based on whether the at least one label matches the element, outputting, based on the fused grid map, a signal, and controlling, based on the signal, autonomous driving of the vehicle.

### CROSS REFERENCE TO RELATED APPLICATION

The present application claims the benefit of priority to a Korean provisional application No. 10-2024-0099526, filed in the Korean Intellectual Property Office on Jul. 26, 2024, the entire contents of which are incorporated herein by reference.

### TECHNICAL FIELD

The present disclosure relates to a method for fusing grid maps obtained based on multi-sensors and a mobility device using the method, and more particularly, to a method for fusing grid maps obtained based on multi-sensors, which generates a grid map with reliability secured by fusing probabilities of respective grids from the grid maps including different information, and a mobility device using the method.

### BACKGROUND

The matters described in this Background section are only for enhancement of understanding of the background of the disclosure, and should not be taken as acknowledgment that they correspond to prior art already known to those skilled in the art.

A semantic segmentation model capable of semantically analyzing a point cloud obtainable using LiDAR may discriminate objects and infer information on the objects. As an example, the semantic segmentation model may effectively represent environmental information for static objects such as guardrails, roads, trees and thickets, which are difficult to clearly specify. Meanwhile, a sensor fusion object detection model, which is capable of processing data obtained from multi-sensors such as a camera and LiDAR, may detect an object by using information obtained from a plurality of sensors and represent the detected object in a bounding box.

As an example, in the case of a sensor fusion object detection model that processes data obtained from a camera and RiDAR, a point cloud including distance information and image information may be fused to perform object detection more accurately, and thus an object detection result may be provided as a bounding box.

Meanwhile, for autonomous driving of a mobility device, because an autonomous driving system should have accurate and reliable detection of environment, an existing grid map including only information on an occupancy probability of an object may not be sufficient for autonomous driving.

Accordingly, fusion with a semantic grid map including not only information on an occupancy probability but also a type of object is used.

On the other hand, as a semantic segmentation model, which analyzes a point cloud, has a high probability of occurrence of misdetection in which a single object includes a plurality of labels as noise, object detection using a single model has limited performance.

Thus, there is a use for a method for generating a grid map including more accurate information on an object through complementation between a single semantic segmentation model capable of analyzing a point cloud and a sensor fusion object detection model capable of processing data obtained from multi-sensors including LiDAR.

### SUMMARY

The effects obtainable from the present disclosure are not limited to the above-mentioned effects, and other effects not mentioned herein will be clearly understood by those skilled in the art through the following descriptions.

According to the present disclosure, a method performed by an apparatus for controlling autonomous driving of a vehicle, the method may comprise generating, based on a segmentation model processing point cloud data, a first semantic grid map, generating, based on an object detection model, a second semantic grid map, adjusting a probability regarding whether occupancy exists for an element included in each grid of the first semantic grid map and the second semantic grid map, and generating a fused grid map by determining, as a representative label, at least one label corresponding to a highest value among final probabilities of the at least one label, wherein the final probabilities are determined based on whether the at least one label matches the element, outputting, based on the fused grid map, a signal, and controlling, based on the signal, autonomous driving of the vehicle.

The object detection model is an artificial intelligence (AI) model configured to perform an object detection task based on the segmentation model processing point cloud data and image data, and wherein the point cloud data and image data are generated based on at least one external object sensed by at least one sensor of the vehicle.

The generating the first semantic grid map may comprise transforming, based on a location of a sensor, at least one coordinate of a point cloud obtained from the sensor into at least one two-dimensional grid coordinate, associating at least one or more of the at least one label with the at least one two-dimensional grid coordinate, wherein the at least one or more of the at least one label are obtained by a semantic segmentation model processing, and determining, for each grid of the first semantic grid map, the probability and a per-label probability based on the associated at least one or more of the at least one label.

The probability may comprise an occupancy probability and a non-occupancy probability, wherein the occupancy probability is derived based on an occupancy reliability of each grid of the first semantic grid map, wherein the non-occupancy probability is based on a first uncertainty probability of each grid of the first semantic grid map, and wherein the first uncertainty probability is adjusted by an uncertainty factor.

The per-label probability is generated to correspond to a specific label based on the first uncertainty probability and based on a ratio of a first number of first points in the at least one two-dimensional grid coordinate to a second number of second points in the at least one two-dimensional grid coordinate, wherein the specific label is added to the first points, and wherein the second points are included in each grid of the first semantic grid map.

The generating the second semantic grid map may comprise placing a bounding box produced by a sensor fusion object detection model on a predefined grid map, designating an inner box and an outer box based on a predetermined deviation from the placed bounding box and generating a sample point in the outer box, and determining, for each grid of the second semantic grid map, the probability based on the generated sample point and a per-label probability, wherein the per-label probability is based on a label of the bounding box, and wherein the bounding box is associated with the generated sample point.

The probability may comprise an occupancy probability and a non-occupancy probability, wherein the occupancy probability and the non-occupancy probability are based on an occupancy probability shape, and based on a preset second uncertainty probability associated with each grid of the second semantic grid map, and wherein the occupancy probability shape is changed based on a shape of an object indicated by the bounding box.

The per-label probability is generated to correspond to the label of the bounding box based on a label uncertainty, wherein the label uncertainty is set based on performance of the sensor fusion object detection model.

The adjusting the probability may comprise reflecting a non-occupancy probability from a grid of the first semantic grid map into an occupancy probability of a corresponding grid in the second semantic grid map, wherein the corresponding grid in the second semantic grid map comprises at least a part of the placed bounding box, assigning a second uncertainty probability to a grid outside the placed bounding box among the grid of the second semantic grid map, and reflecting the probability from the grid of the first semantic grid map corresponding to the outside grid, into an occupancy probability of the outside grid in the second semantic grid map.

The determining the at least one label may comprise determining a probability for a case in which a label of a grid is identical and a probability for a case in which the label of the grid is different, based on a per-label probability assigned to each grid of the first semantic grid map and the second semantic grid map and based on a label uncertainty probability determined by the per-label probability, and determining, based on the probability for the case in which the label of the grid is different, the final probabilities of the at least one label, wherein the final probabilities comprise uncertainty according to the probability for the case in which the label of the grid is identical.

According to the present disclosure, an apparatus for controlling autonomous driving of a vehicle, the apparatus may comprise a processor configured to execute at least one instruction, a memory configured to store the at least one instruction that, when executed by the processor, is configured to cause the apparatus to generate, based on a segmentation model processing point cloud data, a first semantic grid map, generate, based on an object detection model, a second semantic grid map, adjust a probability regarding whether occupancy exists for an element included in each grid of the first semantic grid map and the second semantic grid map, generate a fused grid map by determining, as a representative label, at least one label corresponding to a highest value among final probabilities of the at least one label, wherein the final probabilities are determined based on whether the at least one label matches the element, output, based on the fused grid map, a signal, and control, based on the signal, autonomous driving of the vehicle.

The object detection model is an artificial intelligence (AI) model configured to perform an object detection task based on the segmentation model processing point cloud data and image data, and wherein the point cloud data and the image data are generated based on at least one external object sensed by at least one sensor of the vehicle.

The at least one instruction, when executed by the processor, is further configured to cause the apparatus to generate the first semantic grid map by transforming, based on a location of a sensor, a coordinate of a point cloud obtained from the sensor into at least one two-dimensional grid coordinate, associating at least one or more of the at least one label with the at least one two-dimensional grid coordinate, wherein the at least one or more of the at least one label are obtained by a semantic segmentation model processing, and determining, for each grid of the first semantic grid map, the probability and a per-label probability based on the associated at least one or more of the at least one label.

The probability may comprise an occupancy probability and a non-occupancy probability, wherein the occupancy probability is derived based on an occupancy reliability of each grid of the first semantic grid map, wherein the non-occupancy probability is derived based on a first uncertainty probability of each grid of the first semantic grid map, and wherein the first uncertainty probability is adjusted by an uncertainty factor.

The per-label probability is generated to correspond to a specific label based on the first uncertainty probability and based on a ratio of a first number of first points in the at least one two-dimensional grid coordinate to a second number of second points in the at least one two-dimensional grid coordinate, wherein the specific label is added to the first points, and wherein the second points are included in each grid of the first semantic grid map.

The at least one instruction, when executed by the processor, is further configured to cause the apparatus to generate the second semantic grid map by placing a bounding box produced by a sensor fusion object detection model on a predefined grid map, designating an inner box and an outer box based on a predetermined deviation from the placed bounding box and generating a sample point in the outer box, and determining, for each grid of the second semantic grid map, the probability based on the generated sample point and a per-label probability, wherein the per-label probability is based on a label of the bounding box, and wherein the bounding box is associated with the generated sample point.

The probability may comprise an occupancy probability and a non-occupancy probability, wherein the occupancy probability and the non-occupancy probability are based on an occupancy probability shape and based on a preset second uncertainty probability associated with each grid of the second semantic grid map, and wherein the occupancy probability shape is changed based on a shape of an object indicated by the bounding box.

The per-label probability is generated to correspond to the label of the bounding box based on a label uncertainty, wherein the label uncertainty is set based on performance of the sensor fusion object detection model.

The at least one instruction, when executed by the processor, is further configured to cause the apparatus to adjust the probability by reflecting a non-occupancy probability from a grid of the first semantic grid map into an occupancy probability of a corresponding grid in the second semantic grid map, wherein the corresponding grid in the second semantic grid map comprises at least a part of the placed bounding box, assigning a second uncertainty probability to a grid outside the placed bounding box among the grid of the second semantic grid map, and reflecting the probability from the grid of the first semantic grid map corresponding to the outside grid, into an occupancy probability of the outside grid in the second semantic grid map.

The at least one instruction, when executed by the processor, is further configured to cause the apparatus to determine a probability for a case in which a label of a grid is identical and a probability for a case in which the label of the grid is different, based on a per-label probability assigned to each grid of the first semantic grid map and the second semantic grid map and based on a label uncertainty probability determined by the per-label probability, and determine, based on the probability for the case in which the label of the grid is different, the final probabilities of the at least one label, wherein the final probabilities comprise uncertainty according to the probability for the case in which the label of the grid is identical.

### BRIEF DESCRIPTION OF THE DRAWINGS

FIG. 1 show an example of constituent modules of a device implementing a method for fusing grid maps according to an example of the present disclosure.

FIG. 2 show an example of a method for fusing grid maps according to another example of the present disclosure.

FIG. 3 show an example of modules actually implementing a method for fusing grid maps according to another example of the present disclosure.

FIG. 4 show an example of a method for generating a first semantic grid map according to another example of the present disclosure.

FIG. 5 show an example of a method for generating a first grid map.

FIG. 6 show an example of a method for generating a second semantic grid map according to another example of the present disclosure.

FIG. 7 show an example of a method for generating a second grid map.

FIG. 8 show an example of a method for correcting probabilities of occupancy status included in first and second semantic grid maps in order to fuse grid maps according to another example of the present disclosure.

FIG. 9 show an example of a method for correcting probabilities of occupancy status included in first and second semantic grid maps.

FIG. 10 show an example of a grid map with corrected probabilities of occupancy status.

FIG. 11 show an example of a method for determining a representative label to generate a fused grid map.

FIG. 12 show an example of a mobility device transmitting and receiving data in communication with another device.

FIG. 13 show an example of constituent modules of a mobility device according to the present disclosure.

### DETAILED DESCRIPTION

Herein after, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, expressions of location relations used in the present specification such as “upper”, “lower”, “left” and “right” are employed for the convenience of explanation, and when drawings illustrated in the present specification are inversed, the location relations described in the specification may be inversely understood. When a component, device, element, or the like of the present disclosure is described as having a purpose or performing an operation, function, or the like, the component, device, or element should be considered herein as being “configured to” meet that purpose or perform that operation or function.

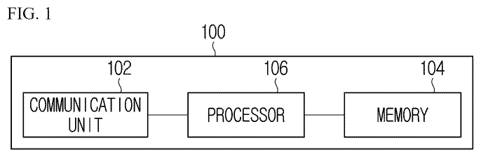

Hereinafter, constituent modules of a device implementing a method for fusing grid maps according to an example of the present disclosure will be described with reference to FIG. FIG. 1 is a view schematically showing constituent modules of a device implementing a method for fusing grid maps according to an example of the present disclosure.

Referring to FIG. 1, a device 100 implementing a method for fusing grid maps (hereinafter, server) may include a communication unit 102, a processor 106 and a memory 104. Each component is not an indispensable component, an additional configuration may be provided or omitted, and one configuration may be included in or combined with another configuration so that a single configuration may perform a plurality of functions. For example, within a scope not violating the description below, a separate module for fusing grid maps may be added apart from the processor 106. In addition or alternative, the processor 106 may include a plurality of modules implementing a method for fusing grid maps according to another example of the present disclosure. Hereinafter, for convenience of description, the method for fusing grid maps will be implemented mainly in the processor 106, and the processor 106 may be abbreviated to the server 100, for convenience of explanation, or these terms may be used interchangeably.

Referring to FIG. 1, the server 100 may generate a grid map by using a result obtained using a semantic segmentation model 310 and also a separate grid map by using a result obtained based on a sensor fusion object detection model 315. As an example, for the semantic segmentation model 310, the server 100 may use the semantic segmentation model 310 capable of processing point cloud data (hereinafter, point cloud) obtained from a LiDAR sensor. In addition or alternative, as an example, for the sensor fusion object detection model 315, the server 100 may use a model capable of processing data obtained from multi-sensors including LiDAR and use, for example, a LiDAR-camera sensor fusion object detection model. For example, a point cloud may comprise a collection of data points in a three-dimensional coordinate system, representing the external surface of an object or environment. Each point in the cloud may have its own set of X, Y, and Z coordinates, and/or additional information (e.g., color or intensity). Point clouds may be generated by 3D scanners, LiDAR, or photogrammetry techniques, and may be used in various applications such as 3D modeling, computer vision, and/or robotics, etc. They may provide a highly detailed and/or accurate representation of complex surfaces and/or structures, making them ideal for tasks like object recognition, environment mapping, and/or digital reconstruction, etc.

Specifically, the semantic segmentation model 310, which processes a point cloud, may mean an artificial intelligence (AI) model that analyzes point clouds collected from a LiDAR sensor and gives meaning to each point. For example, the semantic segmentation model 310 may discriminate point clouds as objects, infer semantic information of corresponding objects, and as an example, effectively express environmental information on static objects such as a guardrail, a road, a tree and a thicket, which are difficult to clearly specify.

The sensor fusion object detection model 315 capable of processing data obtained from multi-sensors including LiDAR may mean an AI model that may detect an object by simultaneously using data obtained from the multi-sensors and express the detected object by a bounding box. As an example, the sensor fusion object detection model 315 according to the present disclosure may either early sensor fusion or later sensor fusion. In addition or alternative, as an example, when employing later sensor fusion, the sensor fusion object detection model 315 may mean an AI model that consists of a model for processing image data collected from a camera and a model for processing point clouds. As an example, in the case of the sensor fusion object detection model 315 consisting of a plurality of models, the sensor fusion object detection model 315 may output a single result by fusing bounding boxes of objects that are obtained as tasks performed for respective models. In addition or alternative, the sensor fusion object detection model 315 may detect or classify a type of an object and perform object tracking in order to detect unique identification information and speed information for an output bounding box.

The model for processing image data may include YOLO (You Only Look Once) employing a convolutional neural network (CNN) structure and an AI model employing regions with convolutional neural network (R-CNN) or transformer structure but is not limited to the above-described example. Likewise, the AI model capable of processing point clouds may include PointNet and VoxelNet but is not limited thereto.

A model referred to in the present disclosure may be referred to in various ways such as network, neural network, learning model, artificial neural network, deep learning model and the like. In addition or alternative, an AI model used in the present disclosure may be trained in advance.

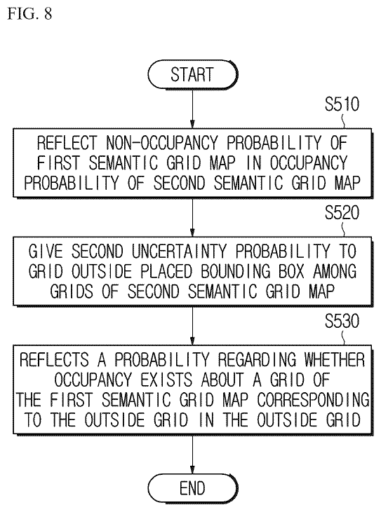

After additionally generating a separate grid map, the server 100 may correct a probability regarding whether occupancy exists based on a probability regarding whether or not an element included in each grid map occupies. Specifically, the server 100 may derive a probability regarding whether occupancy exists with secured reliability by cross-referring to and fusing probabilities regarding whether or not elements included in each grid map occupy. This will be described in detail through FIG. 8 to FIG. 10.

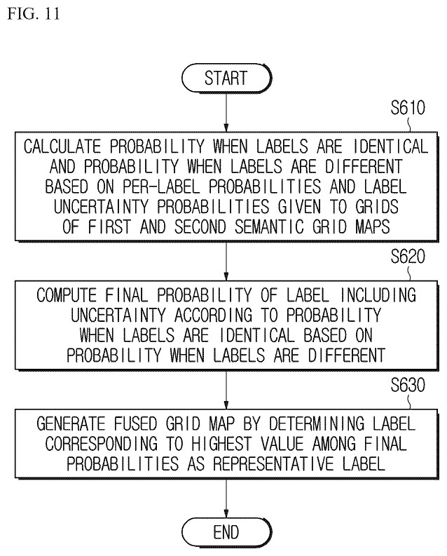

In addition or alternative, in order to fuse grid maps, the server 100 may determine a representative label based on whether or not a label given to the separate grid map is identical. Specifically, based on a per-label probability indicated by a grid of a grid map, the server 100 may obtain a final probability of a label based on whether or not the label is identical. This will be described in detail through FIG. 11.

The server 100 may generate a fused grid map by using a corrected probability regarding whether occupancy exists and a determined representative label, and the fused grid map may include semantic information. As an example, the fused grid map may include not only a probability regarding whether or not an object occupies but also information on the type, location and size of the object. Furthermore, since grid maps obtained based on a semantic segmentation model and a sensor fusion object detection model are fused, not only information on a standardized object but also non-standardized environmental information may be included. A fused grid map obtained by the above-described method may be used for precise environmental detection, thereby improving the performance and reliability of an autonomous driving system.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of fused grid map) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of fused grid map) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of fused grid map) described herein.

Minimum risk maneuver (MRM) operation(s) may also be controlled, for example, based on one or more features (e.g., features of fused grid map) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle if a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of fused grid map) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of fused grid map) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

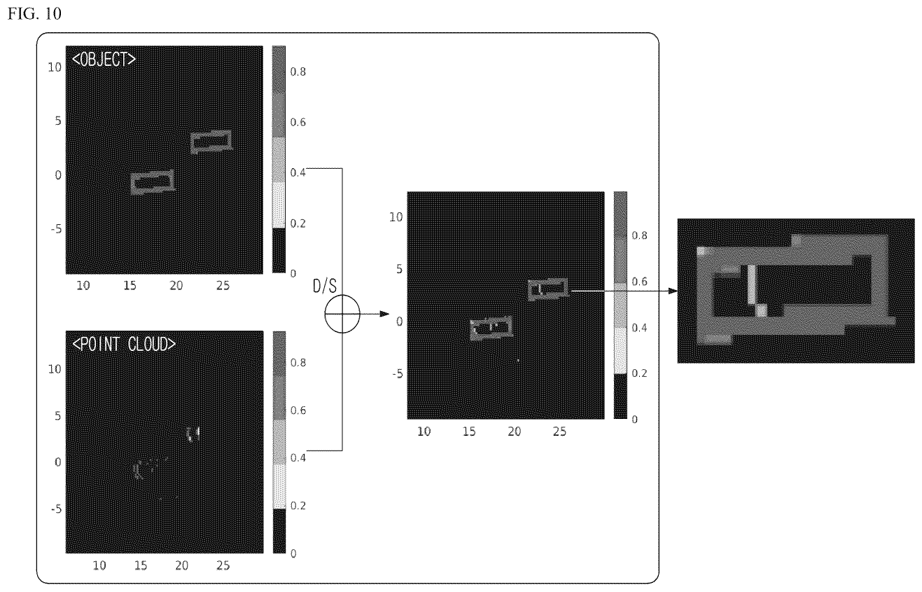

The server 100 may distribute a fusion module 305 capable of generating a fused grid map by actually processing the above-described process to a mobility device (refer to 300 of FIG. 10), and the mobility device 300 may use the described fusion module 305 for driving control.

The mobility device 300 may refer to a device capable of moving to a specific point. The mobility device 300 may be any one of a ground vehicle driven on the ground and a device such as a moving robot controlled autonomously or remotely and a working robot for a specific purpose. In addition or alternative, the mobility device 300 is not limited to the ground mobility device but may be, for example, an aerial mobility device, a water mobility device for water transportation or an underwater mobility device (e.g., submarine). The mobility device 300 may be driven autonomously or manually. The autonomously-driven mobility device 300 may be implemented by either semi-autonomous driving or full-autonomous driving. Full autonomous driving may be provided as autonomous moving under the complete control of a controller of the mobility device 300 without a user's intervention even in an uncertain driving situation. Semi-autonomous driving may be provided as autonomous moving that uses a driver's intervention in a specific driving situation. When the situation occurs, semi-autonomous driving may be implemented such that the controller of the mobility device 300 disables autonomous driving and switches control to the user, and thus the user performs manual driving. According to the autonomous driving levels defined by the Society of Automotive Engineers (SAE), semi-autonomous driving may correspond to the autonomous driving levels 1 to 4, and full autonomous driving may correspond to the level 5.

The server 100 may be a device such as a server provided separately from the mobility device 300 to be operated by, for example, a vehicle manufacturer or operated by a management organization providing a service of autonomous driving. If the server 100 is a server operated by a vehicle manufacturer or a management organization supporting autonomous driving, the server 100 may receive connected data of the mobility device 300 or transmit data necessary for autonomous driving. In order to support autonomous driving or various services of the mobility device 300, the server 100 may transmit various information and software modules used for controlling the mobility device 300 to the mobility device 300 in response to a request and data transmitted from the mobility device 300 and a user device. The present disclosure will describe the processing of the server 100 mainly in relation to a method for fusing grid maps according to an example.

The communication unit 102 of the server 100 may support mutual communication with mobility devices 300 and 400 and an ITS device 300. In the present disclosure, the communication unit 102 may be a communication interface that receives various data and networks (or algorithms) used for generating the fusion module 305 supporting the driving and convenience functions of the mobility device 300 and transmits information and a network related to the fusion module 305 to the mobility device 300. In addition or alternative, the communication unit 102 may be a communication module that receives data generated or stored during driving from the mobility device 300 and transmits information for supporting driving such as map information, environmental information for recognizing an object around the mobility device 300, traffic information and weather information to the mobility device 300. The communication unit 102 may be a communication module that transmits an application related to driving and convenience functions.

The memory 104 may store a program and various data for controlling the server 100, load the program at a request of the processor 106, or read and record the data. The memory 104 may manage the fusion module 305 and learning data used for the fusion module 305. As an example, as for the data, the memory 104 manage point clouds and image data. The image data may include image data of multi-views around the mobility device 300, which are obtained by a camera 204b mounted on a plurality of positions of the mobility device 300. In addition or alternative, of course, the image data may be constructed as sequential data in time series.

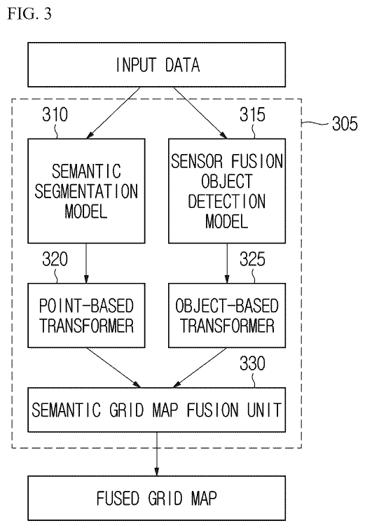

The fusion module 305 may be configured to include functional modules 310, 315, 320, 325 and 330 illustrated in FIG. 3 and to be described below. Data used in the present disclosure may include videos, depth maps, depth information provided in a point cloud format, point clouds and image data, which are collected from the plurality of mobility devices 300 and 400 and/or a conventional DB for learning data. Apart from the above-described data, the memory 104 may also have an application for implementing driving and convenient functions of the mobility device 100, map information, traffic information, weather information and other various types of information affecting driving.

The processor 106 may perform overall control of the server 100. The processor 106 may be configured to execute applications and instructions stored in the memory 104. Specifically, using the above-described learning data, the processor 106 may control the server 100 to establish the processing of the fusion module 305 and to distribute the established fusion module 305 to the mobility device 300.

In order to establish the processing of the fusion module 305, the processor 106 may determine AI models to be employed as the semantic segmentation model 310 and the sensor fusion object detection model 315.

In addition or alternative, the processor 106 may establish labels beforehand in order to reclassify a type of an object in semantic information obtained using the semantic segmentation model 310 into a predefined label. As an example, the processor 106 may establish beforehand an object label allocated according to a specific category of an object, an environment label allocated to environmental information for a non-standardized static object, a dynamic or static label allocated to a standardized object including mobility, a geometric label giving information related to the shape or size of an object, or the like. The above-described labels may be different according to a system setting or a user setting and are not limited to the above-described example. The above-described labels, which are established beforehand, may also be applied likewise to information obtained by the sensor fusion object detection model 315.

In addition or alternative, the processor 106 may receive, from the mobility devices 300 and 400, feedback information according to the operation of the fusion module 305 distributed to the mobility devices 300 and 400 and a same type of data as data used in the fusion module 305 and update the fusion module 305 based on the received information and data. The processor 106 may distribute the updated fusion module 305 to the mobility devices 300 and 400.

In addition or alternative, the processor 106 may perform processing of supporting the driving and convenience functions of the mobility device 300. In the present disclosure, as an example, the processor 106 may be implemented as a single processing module. As another example, the above-described processing may be distributively performed in a plurality of processing modules, and the processor 106 may commonly refer to a plurality of processing modules in the present disclosure.

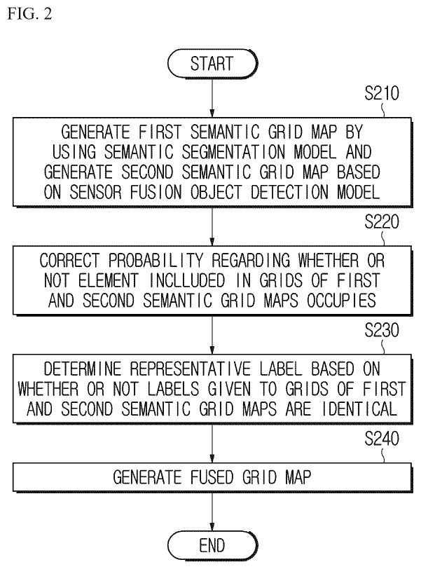

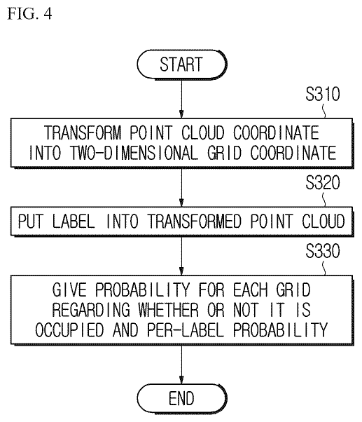

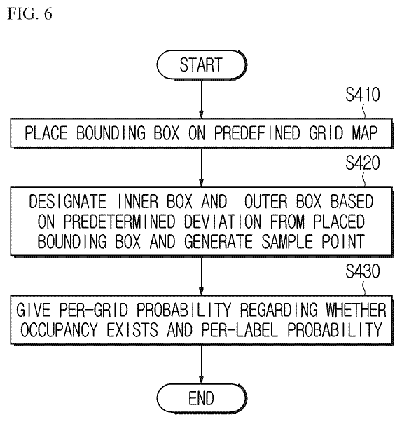

For convenience, FIG. 2, FIG. 4, FIG. 6, FIG. 8, and FIG. 11 are described by way of examples in which the steps are performed by a processor (e.g., control circuitry). One, some, or all steps of FIG. 2, FIG. 4, FIG. 6, FIG. 8, and FIG. 11, or portions thereof, may be performed by one or more other circuits. One or some, steps of FIG. 2, FIG. 4, FIG. 6, FIG. 8, and FIG. 11 may be omitted, performed in other orders, and/or otherwise modified, and/or one or more additional steps may be added.

Hereinafter, a method for fusing grid maps according to another example of the present disclosure will be described in detail through FIG. 2 and FIG. 3.

FIG. 2 is a flowchart of a method for fusing grid maps according to another example of the present disclosure. FIG. 3 is a view showing the structure of modules actually implementing a method for fusing grid maps according to another example of the present disclosure. The modules actually implementing the method for fusing grid maps in FIG. 3 may be software modules processed by the processor 106, and the processor 106 may process requests from the modules listed in FIG. 3.

In the present disclosure, processing of the fusion module 305 according to an example is described to be performed only in the server 100, but the fusion module 305 described below may also be processed by being distributed between the server 100 and another device within a scope deviating from the description below. For example, the another device may be a server and/or the mobility devices 300 and 400.

Referring to FIG. 2, the processor 106 of the server 100 generates a first semantic grid map by using the semantic segmentation model 310 and generates a second semantic grid map based on the sensor fusion object detection model 315 (S210). A semantic grid map may be a structured representation of an environment that combines spatial and semantic information to provide a detailed understanding of the surroundings. The environment is divided into a grid, with each cell corresponding to a specific area and containing data about whether the cell is occupied or free, as well as semantic labels that describe what is present in the cell, such as roads, walls, trees, cars, or pedestrians. These labels may be generated using data from sensors like cameras, LiDAR, or radar, processed through advanced algorithms like deep learning. In addition or alternative to semantic labels, each cell can also store probabilistic information, such as the likelihood that it is occupied, the confidence in the assigned label, and the uncertainty of the data. Semantic grid maps may integrate data from multiple sensors to ensure accuracy and richness. Unlike regular grid maps, which may only indicate whether a cell is occupied, semantic grid maps may add meaningful labels to describe the type of object or surface, enhancing the system's ability to understand the environment. These maps are useful for autonomous systems, such as self-driving cars and robots, enabling them to identify free spaces, distinguish between different types of objects, plan safe paths, and make informed decisions. For instance, a semantic grid map may identify one cell as a road, another as a car, and yet another as a pedestrian, allowing a self-driving car to navigate safely and effectively.

Input data used in the present disclosure may be a point cloud obtained from LiDAR and a camera mounted on the mobility device 300 or another device in time series or successively, a static image and/or video data representing a series of motions in an object by successive frames. In addition or alternative, image data may be an image obtained from a surrounding environment of an ego-vehicle, which is changing from the perspective of the running ego-vehicle, or an multi-view image obtained from a surrounding environment that is changing according to each of multi-cameras mounted on the ego-vehicle.

As an example, in the semantic segmentation model 310, a point cloud obtained from LiDAR may be used as input data. In addition or alternative, as an example, the sensor fusion object detection model 315 may use a point cloud and image data as input data.

The processor 106 may generate environmental information on not only a standardized object but also a non-standardized object in respective LiDAR points. Next, the processor 106 gives predefined labels to respective LiDAR points including semantic information and transforms an output result of the semantic segmentation model 310 to a two-dimensional grid map (hereinafter, first semantic grid map). The processing of transforming the output result of the semantic segmentation model 310 to the two-dimensional grid map may be performed as the processor 106 performs a request from the point-based transformer 320.

In addition or alternative, the processor 106 may detect a bounding box by using the sensor fusion object detection model 315 and generate a label for an object inferred by the bounding box and coordinate information of the bounding box. For the label, a predefined label may be used. In addition or alternative, the processor 106 may connect a tracking algorithm for the bounding box to prevent an inaccurate bounding box from being destroyed. Next, the processor 106 transforms an output result of the sensor fusion object detection model 315 to a two-dimensional grid map (hereinafter, second semantic grid map). That is, the processor 106 locates the bounding box on a preset grid map. The processing of transforming the output result of the sensor fusion object detection model 315 to the two-dimensional grid map may be performed as the processor 106 performs a request from the object-based transformer 325.

Specifically, the processor 106 may transform the above-described output result to a two-dimensional grid map (the first semantic grid map and the second semantic grid map) through a grid map transformation logic around an ego-vehicle or a component (e.g., LiDAR, a camera) obtaining input data, and the two-dimensional grid map thus transformed may include a probability regarding whether occupancy exists including uncertainty and a per-label probability.

As an example, the processor 106 may use a mapping lookup table to transform output results of the semantic segmentation model 310 and the sensor fusion object detection model 315 to two-dimensional grid maps. The mapping lookup table may include a transform matrix and a matrix vector for common coordinate transformation from a LiDAR coordinate system or a camera coordinate system to a vehicle coordinate system, a world coordinate system or a pre-designated coordinate system (e.g., a two-dimensional grid map coordinate system), and the transform matrix and the transform vector may be defined by external geometry or internal geometry of the mobility device 300. In this case, the external geometry or internal geometry may be obtained beforehand by calibration.

A process of generating a grid map by the processor 106 by giving a probability regarding whether occupancy exists and a per-label probability to a grid through a grid map transformation logic will be described in detail through FIG. 4 to FIG. 7.

Next, the processor 106 corrects the probability regarding whether occupancy exists based on probabilities regarding whether or not elements occupy in grids of the first and second semantic grid maps (S220).

Specifically, an element included in the first semantic grid map may mean a point cloud with its coordinate being transformed into a two-dimensional grid map. In addition or alternative, an element included in the second semantic grid map may mean a bounding box with its coordinate being transformed into a two-dimensional grid map.

In addition or alternative, the probability regarding whether occupancy exists may include an occupancy probability containing uncertainty, a non-occupancy probability, and an uncertainty probability.

Specifically, in the case of a deep learning-based cognitive system, a task is performed based on a model that is trained based on specific learning data, there is a limitation in that an object of a class not present in the learning data is impossible to recognize. For example, in the case of an AI model that analyzes a point cloud, it is impossible to detect whether or not there is an object in a non-detection region that occurs due to interference or blocking within a range where measurement is performed. As described above, a state, which is not certainly reliable in a result of a model, may be defined as uncertainty as a higher concept. In addition or alternative, an output result of a different model may have an independent probability and uncertainty.

As an example, the sum of a probability of occurrence of an accident (m_{A}) and a probability of non-occurrence of the accident (m_{˜A}) may not be 1. Accordingly, a remaining probability excluding the probability of occurrence of the accident (m_{A}) and the probability of non-occurrence of the accident (m_{˜A}) may be defined as an uncertainty probability (m_{g}).

Accordingly, the processor 106 generates the first and second semantic grid maps by determining a probability regarding whether or not each grid is occupied through a different grid map transformation logic for each of the models 310 and 315. Consequently, each of the grids of the first and second semantic grid maps, which are generated based on output results of the semantic segmentation model 310 and the sensor fusion object detection model 315, includes an independent probability regarding whether or not it is occupied. Detailed processing thereof will be described below.

The processor 106 may correct the probability through cross-reference between probabilities regarding whether or not a corresponding grid is occupied, thereby minimizing uncertainty.

Next, the processor 106 determines a representative label based on whether or not predefined labels given to the first and second semantic grid maps are identical (S230). As described at step S220, a given label may also have uncertainty. Accordingly, the processor 106 generates a probability for each label with uncertainty being reflected through a different grid map transformation logic for each of the models 310 and 315. Thus, a probability for each label generated in each of the semantic grid maps is independent likewise.

Consequently, based on probabilities for respective labels given to the first and second semantic grid maps, the processor 106 may determine a probability regarding whether or not the labels are identical and may determine a representative label based on the determined probability. Detailed processing thereof will be described below.

Finally, through steps S220 and S230, the processor 106 may generate a fused grid map (S240), and the processing of step S220 and S230 may be performed as the processor 106 performs a request from the semantic grid map fusion unit 330.

Herein, the process of transforming a point cloud to the first semantic grid map will be described in detail through FIG. 4. For convenience of description, the processing in each of the modules illustrated in FIG. 3 will be commonly described to be performed in the processor 106. FIG. 4 is a flowchart of a method for generating a first semantic grid map according to another example of the present disclosure.

The processor 106 transforms a point cloud coordinate into a coordinate of a two-dimensional grid map through a grid map transformation logic (S310). As an example, through the grid map transformation logic, the processor 106 may obtain a coordinate of the point cloud on the two-dimensional grid map. More specifically, the processor 106 may use a mapping lookup table to transform a point cloud coordinate into a coordinate on the two-dimensional grid map, and the point cloud and the predefined two-dimensional grid map are mapped based on a coordinate system of a component obtaining point clouds, that is, LiDAR.

Next, the processor 106 puts a predefined label into a transformed point cloud (S320). That is, semantic information included in the transformed point cloud may be reclassified into the predefined label. Thus, the processor 106 classifies a label put into a point cloud included in each grid and calculates the number of transformed points included in each grid and the number of points according to each label.

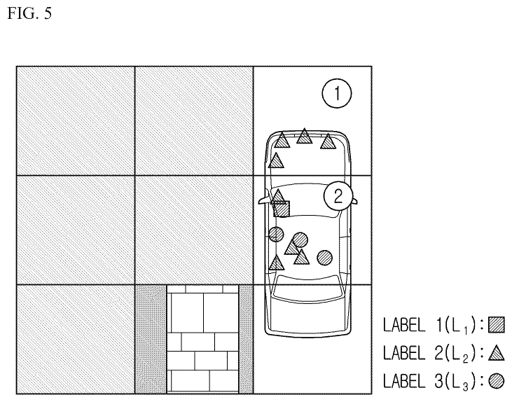

For convenience of understanding, FIG. 5 will be described together. FIG. 5 is a view exemplifying an example of a method for generating a first grid map.

Referring to FIG. 5, in the case of Grid 1 illustrated in FIG. 5, points irradiated on a four-wheeled car may be reclassified into a predefined Label 2 L₂ according to a predetermined criterion. Meanwhile, in the case of Grid 2, irradiated points may be reclassified into Label 1 L₁, Label 2 L₂, and Label 3 L₃. FIG. 5 illustrates three types of predefined labels but is not limited thereto.

As an example, the processor 106 may give an object label, an environment label, a dynamic label or a static label, or a geometric label to each point based on semantic information in a point cloud. The above-described labels may include information on the class of an object and the behavior or shape of the object.

In addition or alternative, the processor 106 calculates a total number (4) of transformed points included in Grid 1 and the number of points according to each label (4 points in Label 1). Likewise, the processor 106 calculates a total number (8) of transformed points included in Grid 2 and the number of points according to each label (1 point in Label 1, 4 points in Label 2, 3 points in Label 3).

On the other hand, in case there is inference (the wall of FIG. 5) within a range where measurement is performed using LiDAR, there may be no point cloud for a region that is not detected because of the interference. Accordingly, in this case, a grid representing the region may have no point cloud.

Next, the processor 106 calculates a probability for each grid regarding whether or not it is occupied and a per-label probability and gives the probability to each grid (S330).

Specifically, based on an uncertainty probability of a grid (hereinafter, first uncertainty probability) that is adjusted by an uncertainty factor, the processor 106 calculates a probability regarding whether or not the grid is occupied, which includes an occupancy probability and a non-occupancy probability that are derived from an occupancy reliability of the grid. In addition or alternative, when calculating the first uncertainty probability, the processor 106 may refer to the number of points included in each grid.

Referring to FIG. 5 again, the processor 106 calculates a total number of points (N_{T}) included in each grid before determining a probability regarding whether or not the grid is occupied and a per-label probability. The total number of points may be determined by Formula 1 below.

$${N}_{T} = {N}_{L 1} + {N}_{L 2} + {N}_{L 3} + … \qquad [ Formula 1 ]$$

Here, N_{L1}, N_{L2}, N_{L3} and the like mean the number of points of each label, and in the case of Label 1, N_{L2} is determined as 4, and the total number of points N_{T} is determined as 4 because there is no point to which a different label is given. In the same way, N_{L1}, N_{L2} and N_{L3} of Grid 2 are determined as 1, 4 and 3 respectively, and N_{T} is determined as 8.

Next, the processor 106 calculates an uncertainty probability mᵤₙ, which quantifies information uncertainty of each grid, and produces a first uncertainty probability through the total number of points N_{T} and the uncertainty factor αᵤ. Specifically, the uncertainty probability mᵤₙ is obtained by Formula 2 below.

$${m}_{u n} = \frac{1}{1 + {e}^{{α}_{u} {N}_{T}}} , {N}_{T} \geq 0 \qquad [ Formula 2 ]$$

The uncertainty factor αᵤ may be differently set according to a system setting or a user setting, and any number between 0 and 1 may be designated. In the case of Grid 1 of FIG. 5, if 0.5 is designated as the uncertainty factor αᵤ, the uncertainty probability of Grid 1

$$( )$$

may be determined as

$$= \frac{2}{1 + {e}^{{α}_{u} {N}_{T}}} = \frac{2}{1 + {e}^{0.5 \times 4}} = 0.238 .$$

Likewise, the uncertainty probability of Grid 2 [symbol] may be determined as

$$= \frac{1}{1 + {e}^{{α}_{u} {N}_{T}}} = \frac{2}{1 + {e}^{0.5 \times 8}} = 0.036 .$$

Then, based on the first uncertainty probability produced by the above-described method, the processor 106 produces an occupancy probability m_{O} and a non-occupancy probability m_{F} that are derived by an occupancy reliability γₒ of a grid. Specifically, the occupancy probability m_{O} and the non-occupancy probability m_{F} may be determined by Formula 3 below.

$${γ}_{o} = min [ 1 , {log}_{N} ( {N}_{T} ) ] \qquad [ Formula 3 ]$$

$${m}_{o} = ( 1 - {m}_{u n} ) \times {γ}_{o ′} {m}_{F} = ( 1 - {m}_{u n} ) \times ( 1 - {γ}_{o} )$$

A value between 0 and 1 may be designated for the occupancy reliability γₒ, a different value may be designated according to each grid. As the occupancy reliability γₒ is a value representing the reliability of a grid, the occupancy reliability γₒ may be designed to have a larger value along with an increasing total number N_{T} of points included in the grid. As an example, the occupancy reliability γₒ may be designated as a smaller value between a logarithmic value of the total number of points log_{N} (N_{T}) and 1. A base number N of a logarithm is a total permissible number of points for each grid, and any value may be designated. In addition or alternative, as shown in Formula 3, the sum of an occupancy probability m_{O} and a non-occupancy probability m_{F}, which are derived based on an occupancy reliability γₒ and an uncertainty probability mᵤₙ is not 1 because there is uncertainty, and the probability of 1 is produced only when the occupancy probability m_{O}, the non-occupancy probability m_{F} and the uncertainty probability mᵤₙ are all added up. That is, the occupancy probability m_{O} and the non-occupancy probability m_{F} according to the present disclosure may be designed to include uncertainty.

In the case of Grid 1 of FIG. 5, if the logarithmic base number N is designated as 10, an occupancy reliability [symbol] , an occupancy probability [symbol] and a non-occupancy probability [symbol] may be determined as

$$= min [ 1 , {log}_{N} ( {N}_{T} ) = min [ 1 , {log}_{10} ( 4 ) ] = min [ 1 , 0.602 ] = 0.6 \; 02 ,$$

$$= ( 1 - 0.238 ) \times 0.602 = 0.4 \; 59 and = ( 1 - 0.238 ) \times 0.398 = 0.303 ,$$

respectively.

In the case of Grid 2, if the logarithmic base number N is designated as 10, an occupancy reliability [symbol] an occupancy probability [symbol] and a non-occupancy probability [symbol] may be determined as

$$= min [ 1 , {log}_{N} ( {N}_{T} ) = min [ 1 , {log}_{10} ( 8 ) ] = min [ 1 , 0.903 ] = 0.903 , = ( 1 - 0.036 ) \times 0.903 = 0.87 , and = ( 1 - 0.036 ) \times 0.097 = 0.094 ,$$

respectively.

Next, the processor 106 considers an uncertainty probability mᵤₙ and a total number of points N_{T} to give a per-label probability m_{Ln} according to each grid. Specifically, based on the uncertainty probability mᵤₙ, the per-label probability m_{Ln} is generated to correspond to a specific label based on a ratio of the number of points N_{Ln}, into which the specific label is put, to a total number of transformed points N_{T} included in a grid. Specifically, in a first semantic grid map, a per-label probability m_{Ln} given to each grid may be determined by Formula 4 below.

$${m}_{Ln} = \frac{{N}_{Ln}}{{N}_{T}} \times ( 1 - {m}_{un} ) \qquad [ Formula 4 ]$$

In the case of Grid 1 in FIG. 5, as there is no point into which Label 1 and Label 3 are put, the Label 1 probability [symbol] and Label 3 probability [symbol] of Grid 1 may be derived as 0, while the Label 2 probability [symbol] may be determined as

$$= \frac{{N}_{L 2}}{{N}_{T}} \times ( 1 - ) = \frac{4}{4} \times ( 1 - 0.238 ) = 0.762 .$$

In the same way, in the case of Grid 2, per-label probabilities [symbol] may be determined as

$$= \frac{{N}_{L 1}}{{N}_{T}} \times ( 1 - ) = \frac{1}{8} \times ( 1 - 0.036 ) = 0.12 , = \frac{{N}_{L 2}}{{N}_{T}} \times ( 1 - ) = \frac{3}{8} \times ( 1 - 0.036 ) = 0.36 , and = \frac{{N}_{L 2}}{{N}_{T}} \times ( 1 - ) = \frac{3}{8} \times ( 1 - 0.036 ) = 0.36 {L 3}_{} = \frac{{N}_{L 3}}{{N}_{T}} \times ( 1 - ) = \frac{4}{8} \times ( 1 - 0.036 ) = 0.48 ,$$

respectively.

In the above-described formulas and calculation results. a sum of per-label probabilities m_{LN} is not a probability of 1. That is, uncertainty also exists in the per-label probability, and the uncertainty of a per-label probability m_{Ln} (e.g., a label uncertainty probability) in a first semantic grid map obtained based on a semantic segmentation model for processing point clouds may be considered a first uncertainty probability mᵤₙ.

The processor 106 transforms a coordinate of a point cloud into a two-dimensional grid coordinate, puts a predefined label into the transformed point cloud, and generates a first semantic grid map through a grid map transformation logic that gives a probability regarding whether occupancy exists for each grid and a per-label probability determined by the above-described formula.

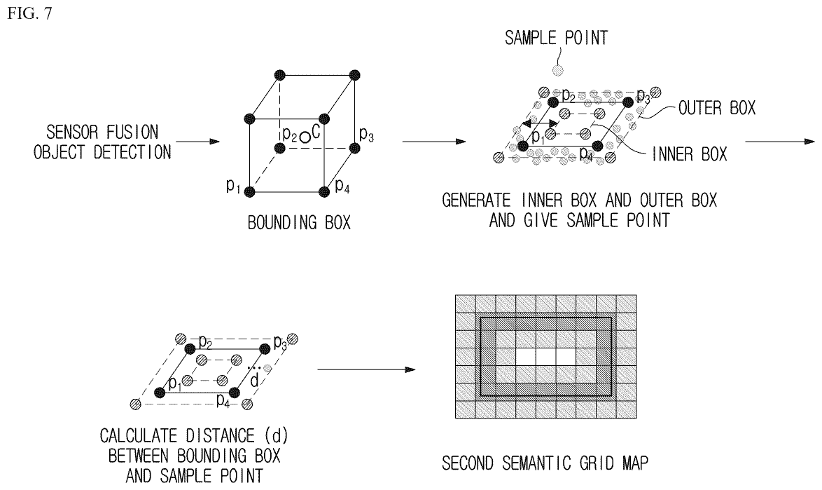

Hereinafter, a process of generating a second semantic grid map by the processor 106 based on a bounding box obtained from the sensor fusion object detection model 315 will be described in detail through FIG. 6 and FIG. 7. Likewise, for convenience of description, the processing in each of the modules illustrated in FIG. 3 will be commonly described to be performed in the processor 106.

FIG. 6 is a flowchart of a method for generating a second semantic grid map according to another example of the present disclosure. FIG. 7 is a view exemplifying an example of a method for generating a second grid map.

The processor 106 places a bounding box obtained from the sensor fusion object detection model 315 on a predefined grid map (S410). As an example, the processor 106 may obtain a coordinate on a two-dimensional grid map coordinate of the bounding box through a grid map transformation logic. The processor 106 may use a mapping lookup table to obtain the coordinate. The mapping lookup may be provided beforehand based on data such as image data input into the sensor fusion object detection model 315 and the geometry information of a component (e.g., a camera and LiDAR).

Next, the processor 106 designates an inner box and an outer box based on a predetermined deviation from the placed bounding box and generates a sample point (S420). The predetermined deviation may be differently set according to a user setting or a system setting, and the processor 106 generates the inner and outer boxes by designating, based on one side of the placed bounding box, one side of each of the inner box and the outer box at both sides of the one side of the bounding box at an interval of the deviation. The inner and outer boxes may be configured in multiple layers according to a setting. In addition or alternative, the processor 106 generates sample points in a space between the bounding box and the inside of the outer box and thus gives an object probability to a grid.

As an example, after generating arbitrary sample points, the processor 106 may compute a feature for each sample point and give an object probability to a grid by aggregating features of respective sample points. As an example, the processor 106 computes an object probability of each sample point based on distance information between the sample point and a component obtaining image data and a point cloud, height information or reflection intensity. In addition or alternative, the processor 106 may determine a sum of object probabilities by cumulating object probabilities of respective sample points. Meanwhile, the processor 106 may calculate, as an object probability, a probability regarding whether occupancy exists, which will be described below.

To generate a second semantic grid map, the processor 106 gives a per-grid probability regarding whether occupancy exists and a per-label probability (S430). For convenience of understanding, FIG. 7 will be described together.

First, in order to secure an occupancy probability among probabilities of occupancy status, the processor 106 computes a closest distance d between sample points inside the outer box and the inner box generated based on a predetermined deviation σ and four sides (p̅₁̅p̅₂̅, p̅₂̅p̅₃̅, p̅₃̅p̅₄̅, p̅₄̅p̅₁̅) of the placed bounding box.

Next, the processor 106 calculates the occupancy probability mₒ based on an occupancy probability shape β_{P}, which is changed according to the shape of an object indicated by the bounding box, and an uncertainty probability (hereinafter, second uncertainty probability) that is a pre-designated value according to the performance of the sensor fusion object detection model 315. The occupancy probability mₒ may be determined by Formula 5 below.

$${m}_{o} = ( 1 - {m}_{un} ) \times {e}^{- \frac{d}{2 {β}_{P}}} \qquad [ Formula 5 ]$$

According to Formula 5, as the distance d between the sample point and the bounding box increases, the occupancy probability mₒ decreases. In addition or alternative, as an example, the second uncertainty probability mᵤₙ may be designed to be proportional to the distance d to the bounding box.

The probability regarding whether occupancy exists mₒ consists of the non-occupancy probability m_{F} and the uncertainty probability mᵤₙ, the non-occupancy probability mᵤₙ may be obtained by m_{F}=1−mᵤₙ−mₒ.

Meanwhile, the processor 106 considers label uncertainty to give a per-label probability m_{Ln} to each grid, and the label uncertainty may be determined based on the performance of the sensor fusion object detection model 315. In a second semantic grid map, the label uncertainty may be a concept encompassing a label uncertainty probability m_{L, un} and a shape of a label probability β_{L}. Like a first semantic grid map, the processor 106 may use a second uncertainty probability mᵤₙ as the label uncertainty probability m_{L, un}. Specifically, in the second semantic grid map, a per-label probability m_{Ln} given to each grid may be determined by Formula 6 below.

$${m}_{L} = ( 1 - {m}_{L , un} ) \times {e}^{- \frac{d}{2 {β}_{L}}} \qquad [ Formula 6 ]$$

According to Formula 6, as the distance d between a sample point and a bounding box, a per-label probability m_{Ln} decreases. In addition or alternative, a label uncertainty probability m_{L, un} may be designed to be proportional to a distance d to the bounding box.

The processor 106 generates a second semantic grid map through the above-described process, and as a probability regarding whether occupancy exists and a per-label probability are values based on a distance between a placed bounding box and a sample point, a relatively distant grid from the placed bounding box may have a decreased probability. The decrease of probability may be understood as an increase of uncertainty, and for convenience of understanding, FIG. 5 illustrates that a distant grid from a bounding box placed on a grid map has decreasing color intensity because of a decreasing probability (or increasing uncertainty).

Finally, the processor 106 fuses the first and second semantic grid maps to generate a semantic grid map capable of comprehensive object information. The grid map fusing the first and second semantic grid maps includes non-standardized environmental information and information on objects with standardized shapes without omission, and thus an autonomous driving system based on the grid map may have improved performance and reliability.

A process of generating a fused grid map by the processor 106 will be described in detail through FIG. 8 to FIG. 10. FIG. 8 is a flowchart of a method for correcting probabilities of occupancy status included in first and second semantic grid maps in order to fuse grid maps according to another example of the present disclosure.

The processor 106 reflects a non-occupancy probability of the first semantic grid map in an occupancy probability of the second semantic grid map (S510). Specifically, the processor 106 may decrease the occupancy probability by reflecting a non-occupancy probability for a grid of the first semantic grid map corresponding to a grid of the second semantic grid including at least a part of a placed bounding box in the occupancy probability of the grid of the second semantic grid map.

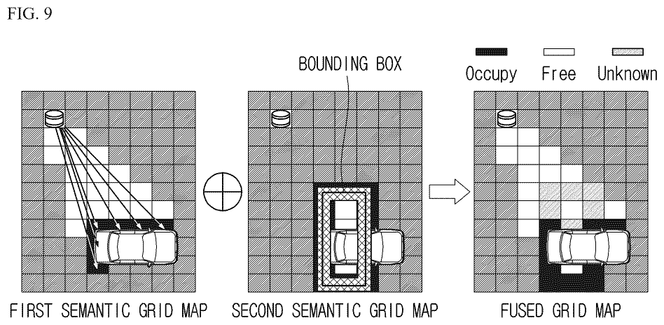

For convenience of understanding, a supplementary description will be provided through FIG. 9. FIG. 9 is a view exemplifying an example of a method for correcting probabilities of occupancy status included in first and second semantic grid maps.

In FIG. 9, a grid with relatively high uncertainty for the first and second semantic grid maps is illustrated in grey, a grid with a relatively high occupancy probability is illustrated in black, and a grid with a relatively high non-occupancy probability is illustrated in white. In addition or alternative, in FIG. 9, even when an occupancy probability in a specific grid is relatively high, if the occupancy probability is relatively lower as compared to another grid, such hierarchy is represented by color intensity.

For convenience of understanding, FIG. 9 allocates colors only to visually represent relatively high values among probabilities of occupancy status given to respective grids, but this does not mean exclusion of other probabilities than probabilities corresponding to those colors. In addition or alternative, of course, the colors do not mean that a probability regarding whether or not a corresponding grid is occupied is not determined.

In FIG. 9, the processor 106 fuses a non-occupancy probability of a first semantic grid map corresponding to a grid including at least a part of a bounding box placed in a second semantic grid map and an occupancy probability of a grid including at least a part of the bounding box. The non-occupancy probability of the first semantic grid map is relatively high, and it means that uncertainty is relatively low. As a point cloud of LiDAR is generated to be closer to an actual object as compared to a bounding box, a relatively high occupancy probability of a grid including the bounding box may be reduced by a reliable non-occupancy probability. As a result of fusion, the occupancy probability of the grid may be reduced, and it is possible to provide a more reliable result about whether or not an object is present.

Next, the processor 106 gives a second uncertainty probability to a grid outside the placed bounding box among grids of the second semantic grid map (S520). As the processor 106 does not place any sample point in a zone without bounding box during the process of generating the second semantic grid map, there may be no probability regarding whether or not it is occupied. Herein, the outside grid means a grid outside a space occupied by the bounding box and may mean a grid of an area excluding an intersection between an inside space of an outer box and an outside space of an inner box.

Meanwhile, in FIG. 9, in the second semantic grid map, the outside area of the outer box designated based on a predetermined deviation from the bounding box is colored in a grid with relatively high uncertainty for the purpose of illustration. On the other hand, the inside area of the inner box is colored in a grid with a relatively high absence probability for the purpose of illustration.

Consequently, the processor 106 gives a second uncertainty probability to the grid outside the bounding box and thus depends on information of the first semantic grid map.

Specifically, the processor 106 reflects a probability regarding whether occupancy exists about a grid of the first semantic grid map corresponding to the outside grid in the outside grid (S530). As shown in FIG. 9, in the case of a grid corresponding to the outside of the outer box including the bounding box, the non-occupancy probability increases as a result of reflecting the probability regarding the first semantic grid map is occupied, and thus the reliability of a grid in an uncertain area is improved. On the other hand, in the case of a grid corresponding to the inside of the inner box of the bounding box, if a probability regarding whether or not the first semantic grid map is occupied is reflected, a presence probability of the grid with the relatively high absence probability in the second semantic grid map is increased.

Hereinafter, an example will be described where an error occurring because of a location error of a bounding box is corrected by adjusting a probability regarding whether or not a second semantic occupancy map is occupied through information obtained based on a point cloud of LiDAR, that is, a probability regarding whether or not a first semantic occupancy map is occupied. FIG. 10 is a view exemplifying a grid map with corrected probabilities of occupancy status. As shown in FIG. 10, in the case of a fused grid map generated through the fusion process described through FIG. 8 to FIG. 9, an occupancy probability of a grid with an actual object is increased. That is, the processor 106 corrects a location of a misdetected object by fusing a plurality of AI models on a grid map.

Next, a process of determining a representative label of each grid based on a per-label probability of first and second semantic grid maps will be described. FIG. 11 is a flowchart of a method for determining a representative label to generate a fused grid map.

First, based on per-label probabilities and label uncertainty probabilities given to grids of first and second semantic grid maps, the processor 106 calculates a probability if labels are identical and a probability if labels are different (S610). As an example, the probability if labels are identical Lₙ and the probability if labels are different L_{˜n} may be determined by Formula 7 below.

$$\begin{matrix}{L}_{n} = {M}_{point , {L}_{n}} \times {M}_{BB , {L}_{n}} + {M}_{point , {L}_{n}} \times {M}_{BB , un} + {M}_{BB , {L}_{n}} \times {M}_{point , un} \\ {L}_{\sim n} = {M}_{point , {L}_{1}} \times ( {M}_{BB , {L}_{2}} + {M}_{BB , {L}_{3}} ) + {M}_{point , {L}_{2}} \times ( {M}_{BB , {L}_{1}} + {M}_{BB , {L}_{3}} ) \\ + {M}_{point , {L}_{3}} \times ( {M}_{BB , {L}_{1}} + {M}_{BB , {L}_{2}} ) +\end{matrix} \qquad [ Formula 7 ]$$

M_{point, L}_{ₙ} may mean a per-label probability m_{Ln} of the first semantic grid map, and M_{BB, L}_{ₙ} may mean a per-label probability m_{Ln} of the second semantic grid map. Likewise, M_{point, un} and M_{BB, un} may mean label uncertainty probabilities m_{L, un} of the first and second semantic grid maps respectively.

As an example, when it is assumed that per-label probabilities M_{point, L}_{₁}, M_{point, L}_{₂} and M_{point, L}_{₃} of a specific grid of the first semantic grid map are determined as 0.1, 0.6 and 0.2 respectively and M_{BB, L}_{₁}, M_{BB, L}_{₂} and M_{BB, L}_{₃} are 0, 0.8 and 0.0 respectively, and if M_{point, un} is 0.1 and M_{BB, un} is 0.2, L₁, L₂ and L₃ may be determined as 0.02, 0.68 and 0.04 respectively.

Meanwhile, under the above-described assumption, the probability when labels are different L_{˜n} may be determined as 0.24.

Next, based on the probability when labels are different, the processor 106 computes a final probability of a label including uncertainty according to the probability when labels are identical (S620). As an example, under the assumption that the probability when labels are different is recognized as uncertainty, the processor 106 may compute a final probability m_{L}_{_{fn}} of each label according to the magnitude of the probability if label are identical as compared to the uncertainty.

As an example, the processor 106 computes the final probability m_{L}_{_{fn}} of a label by determining a probability when labels are identical as compared to a value obtained by subtracting a probability when labels are different from a highest probability such as a probability of 1. For example, the processor 106 may compute the final probability m_{L}_{_{fn}} of each label through Formula Lₙ/(1−L_{˜n}). When the final probability of each label is computed based on the above-described assumption,

$${m}_{{L}_{f 1}} = \frac{0.02}{1 - 0.24} = 0.03 , {m}_{{L}_{f 2}} = \frac{0.68}{1 - 0.24} = 0.89 , and {m}_{{L}_{f 3}} = \frac{0.04}{1 - 0.24} = 0.05$$

are determined.

Next, the processor 106 generates a fused grid map by determining a label corresponding to a highest value among final probabilities as a representative label (S630). As an example, the processor 106 determines Label 2, which is determined as a highest value among final probabilities, as a representative label and generates a fused grid map by putting the determined representative label into a grid map.

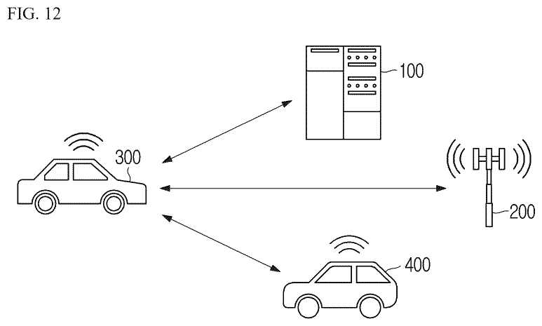

FIG. 12 is a view exemplifying a mobility device transmitting and receiving data in communication with another device.

As described above in FIG. 1, the mobility device 300 may refer to a device capable of moving to a specific point. In the present disclosure, the mobility device 300 is described by an example of a vehicle driven on the ground, but the present disclosure may also be applied to a mobility device for air or water transportation. As described in FIG. 1, the mobility device 300 may be driven by being controlled in autonomous driving, and the autonomous driving may be implemented by semi-autonomous driving or full-autonomous driving.

The mobility device 300 may be driven based on electric energy or fossil energy. In the case of electric energy, for example, the mobility device 300 may be a pure battery-based mobility driven only by a high-voltage battery or employ a gas-based fuel cell as an energy source. In addition or alternative, the fuel cell may use various types of gas capable of generating electric energy, and for example, the gas may be hydrogen. However, without being limited thereto, various gases are applicable. In the case of fossil energy, the mobility device 300 is driven based on fuels such as gasoline, diesel, or liquefied gas, and may be equipped with an engine that drives a wheel drive unit 214 by combustion of the fuel. The engine may be included in a power source unit 212 from a perspective of providing a driving torque of a wheel to the wheel drive unit 214. As another example, the mobility device 300 may be driven by a hybrid scheme of electric energy and fossil energy.

Meanwhile, the mobility device 300 may communicate with other devices 100 and 200 or another mobility device 400. For example, another device may include the server 100 for supporting various control, state management and driving of the mobility device 300, the ITS device 200 for receiving information from an intelligent transportation system (ITS), and various types of user devices. For example, as described in FIG. 1, the server 100 may be an external device operated by a vehicle manufacturer or a management organization providing an autonomous driving service.

For example, the ITS device 200 may be a road side unit (RSU), and the ITS device 200 may assist a user in driving his own car or support autonomous driving of the mobility device 300 by exchanging vehicle recognition data, driving control and situation data, environment data surrounding a vehicle, and map data through V2I with the mobility device 300. Through V2V with the another mobility device 400, the mobility device 300 may support a driver's driving his own car or autonomous driving by exchanging the above-listed data.

The mobility device 300 may communicate with another vehicle or another device based on cellular communication, wireless access in vehicular environment (WAVE) communication, dedicated short range communication (DSRC) or short range communication, or any other communication scheme.

For example, the mobility device 300 may use LTE as a cellular communication network, a communication network such as 5G, a WiFi communication network, a WAVE communication network, and the like to communicate with the server 100, the ITS device 200, and another mobility 400. As another example, DSRC used in the mobility device 300 may be used for mobility-to-mobility communication. A communication scheme among the mobility device 300, the server 100, the ITS device 200, another mobility device 400, and a user device is not limited to the above-described example.

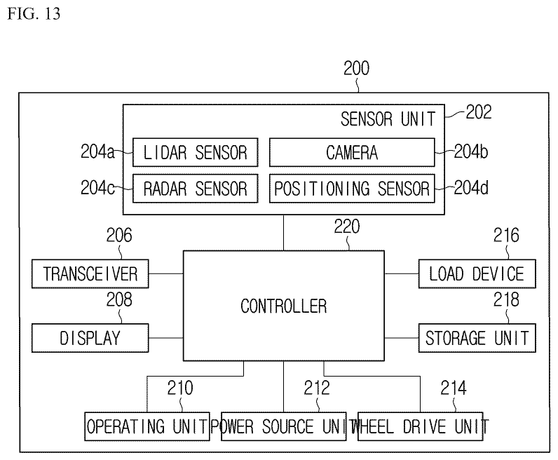

FIG. 13 is a view schematically showing constituent modules of a mobility device according to the present disclosure. The mobility device 300 of FIG. 13 exemplifies a ground vehicle.

The mobility device 300 may include a sensor unit 202, a transceiver 206 and a display 208.

The sensor unit 202 may be equipped with various types of detectors for sensing various states and situations occurring in external and internal environments of the mobility device 300 and for identifying or determining location information of the mobility device 300. That is, the sensor unit 202 may be configured as a multi-sensor module including heterogeneous sensors to obtain sensing data detected from each of the sensors.

Specifically, the sensor unit 202 may be equipped with a LiDAR sensor 204a, a camera 204b as a video sensor, and a radar sensor 204c for recognizing dynamic and static objects present around the mobility device 300 and have a positioning sensor 204d capable of obtaining location information of a vehicle. The sensor unit 202 may obtain sensor data including three-dimensional recognition data, perception/observation data, and positioning information by the above-described sensors.

The LiDAR sensor 204a may be a sensor that observes a surrounding environment based on laser scanning and perceives a three-dimensional shape of an object.

The camera 204b may obtain two-dimensional image data about a surrounding environment and objects of the mobility device 300 or an image (or image data) with depth information in time series. The camera 204b may be installed in a plurality of portions of the mobility device 300 so that a plurality of images or a multi-view may be obtained for the surrounding environment of the mobility device 300. That is, the camera 204b may obtain information on a surrounding environment that is not only in time series but also in succession from the perspective of the mobility device 300.

For example, the radar sensor 204c may irradiate an electromagnetic wave with a predetermined wavelength and thus detect a behavior of an object based on an electromagnetic wave reflected from the object. For example, the behavior of an object may include the presence of the object, whether the object moves, a distance between the mobility device 300 and the object, a speed of the object, and a movement direction.

Apart from the positioning sensor 204d, the sensor unit 202 may be equipped with a gyro sensor, an acceleration sensor, a wheel sensor, an autometer, a speed sensor and the like, in order to identify or determine its own location, driving position, and speed. In addition or alternative, to monitor a user inside the mobility device 300, a condition of an occupant, and an operating situation of an internal device of the mobility device 300 that a user is capable of maneuvering, the sensor unit 202 may have an inward-facing image sensor, a biosensor for detecting biosignals of a driver and an occupant, and various detection modules for detecting the operation and state of an internal device.

The present disclosure mainly describes sensors of the sensor unit 202 referred to for description of an example but may further include a sensor for detecting various situations not listed herein.

The transceiver 206 may support mutual communication with the server 100, the ITS device 200, and the neighbor mobility device 400. In the present disclosure, the transceiver 206 may data generated or stored during driving to the server 100 and receive data and software modules transmitted from the server 100. In the present disclosure, the mobility device 300 may transmit and receive data used in the method according to the present disclosure to and from the outside through the transceiver 206.

The display 208 may serve as a user interface. By the controller 106, the display 208 may display an operating state and a control state of the mobility device 300, path/traffic information, information on an energy remaining quantity, a content requested by a driver, and the like to be output. The display 208 may be configured as a touch screen capable of sensing a driver input and receive a request of a driver indicated to the processor 106.

Meanwhile, the mobility device 300 may include an operating unit 210, a power source unit 212, the wheel drive unit 214, and a load device 216.

The operating unit 210 may be equipped with at least one module for implementing a driving operation and perform at least one driving operation of longitudinal control like acceleration/deceleration and transverse control like steering. The operating unit 210 may be equipped with not only a pedal and a steering wheel accepting a user's request for the control but also various operating modules for generating a driving operation according to the request in the wheel drive unit 214.

The power source unit 212 may generate and supply power and electricity used for a driving power system like the wheel drive unit 214 and the load device 216. In case the mobility device 300 is driven based on electric energy, for example, the power source unit 212 may be configured as an electric battery or be configured as a combination of an electric battery and a fuel cell for charging the battery. In the case of a combination of an electric battery and a fuel cell, the power source unit 212 may include a tank for storing a material used to produce power of the fuel cell, for example, hydrogen gas. In case the mobility device 300 is driven based on fossil energy, the power source unit 212 may be configured as an internal combustion engine.

The wheel drive unit 214 may include a plurality of wheels, a driving force transfer module for generating and giving a driving force to wheels or for transferring a driving force, a braking module for decelerating the driving of wheels, and a steering module for realizing transverse control of wheels. In case the mobility device 300 is driven based on electric energy, a driving force transfer module may be configured as a motor module that generates a driving force based on electric power output from an electric battery. In case the mobility device 300 is operated based on fossil energy, a driving force transfer module may be equipped with transmission and a gear module that transfer power of an internal combustion engine.

In the present disclosure, the operating unit 210 and the wheel drive unit 214 may constitute an actuating unit that externally implements a driving motion, a driving pose and the like by transferring power generated from the power source unit 212. In the present disclosure, the actuating unit is referred to as actuator, and these terms may be used interchangeably.

The load device 216 may be an auxiliary equipment mounted on the mobility device 300, which consumes power supplied from the power source unit 212 by use of an occupant or a user. In the present disclosure, the load device 216 may be a type of electric device for non-driving purpose excluding a driving power system like the wheel drive unit 214. For example, the load device 216 may be an air-conditioning system, a light system, a seat system, and various devices installed in the mobility device 300.

In addition or alternative, the mobility device 300 may include a storage unit 218 and a controller 220.

The storage unit 218 may store an application and various data for controlling the mobility device 300, load the application at a request of the controller 220, or read and record the data. In the present disclosure, the storage unit 218 may receive and manage the fusion module 305 from the server 100. In addition or alternative, the storage unit 218 may receive and manage information necessary for driving such as map information, traffic information, weather information and accident information.

The controller 220 may perform overall control of the mobility device 300. The controller 220 may be configured to execute an application and instructions stored in the storage unit 218. Specifically, the controller 220 may use the fusion module 305 stored in the storage unit 218 to perform tasks such as semantic segmentation and object detection by using information from the sensor unit 202. The controller 220 may use various data recognized from the LiDAR sensor 204a, the camera 204b, the radar sensor 204c and the positioning sensor 204d and an output result of the fusion module 305 for autonomous driving control. Specifically, the controller 220 may use a fused grid map produced by the stored fusion module 305 as input data of an AI model used for the autonomous driving control.

In the present disclosure, as an example, the controller 220 may be implemented as a single processing module. As another example, the above-described processed may be handled by being distributed among a plurality of processing modules, and the controller 220 may commonly refer to a plurality of processing modules.

The present disclosure is technically directed to providing a method for fusing grid maps obtained based on multi-sensors, which generates a grid map with reliability secured by fusing probabilities of respective grids from the grid maps including different information, and a mobility device using the method.

The technical problems solved by the present disclosure are not limited to the above technical problems and other technical problems which are not described herein will be clearly understood by a person having ordinary skill in the technical field, to which the present disclosure belongs, from the following description.

A method may be performed by an apparatus for fusing grid maps obtained based on multi-sensors. The method may comprise: generating a first semantic grid map by using a segmentation model processing point cloud data and generating a second semantic grid map based on an object detection model, correcting a probability regarding whether occupancy exists for an element included in each grid of the first and second semantic grid maps and generating a fused grid map by determining, as a representative label, a label corresponding to a highest value among final probabilities of the label that are computed based on whether or not the label is identical for the element included in a grid of the first and second semantic grid maps.

The object detection model may be an artificial intelligence (AI) model that performs an object detection task based on the point cloud data and image data.

The generating of the first grid map may comprise: transforming a coordinate of the point cloud into a two-dimensional grid coordinate based on a location of a component obtaining the point cloud, putting at least one or more of the label obtained by the semantic segmentation model into the transformed point cloud and giving, for each grid, the probability regarding whether occupancy exists and a per-label probability according to the label that is put into the point cloud.

The probability regarding whether occupancy exists may include an occupancy probability derived by an occupancy reliability of the grid and a non-occupancy probability based on a first uncertainty probability of the grid that is adjusted by an uncertainty factor.

Based on the first uncertainty probability of the grid, the per-label probability may be generated to correspond to the specific label based on a ratio of the number of the transformed point cloud, into which the specific label is put, to the number of the transformed point cloud included in the grid.

The generating of the second grid map may comprise: placing a bounding box produced by the sensor fusion object detection model on a predefined grid map, designating an inner box and an outer box based on a predetermined deviation from the placed bounding box and generating a sample point in the outer box and giving, for each grid, the probability regarding whether occupancy exists based on the sample point and the per-label probability according to the label of the bounding box, which is put into the generated sample point.

The probability regarding whether occupancy exists may include an occupancy probability and a non-occupancy probability that are based on an occupancy probability shape, which is changed according to a shape of an object indicated by the bounding box, and a preset second uncertainty probability of the grid.

The per-label probability may be generated to correspond to the label of an object indicated by the bounding box, which is put into the sample point, based on label uncertainty that is set based on performance of the sensor fusion object detection model.

The correcting of the probability regarding whether occupancy exists may comprise: reflecting a non-occupancy probability for the grid of the first semantic grid map corresponding to the grid of the second semantic grid including at least a part of the placed bounding box in an occupancy probability of the grid of the second semantic grid map, giving a second uncertainty probability to the grid outside the placed bounding box among the grid of the second semantic grid map and reflecting the probability regarding whether occupancy exists for the grid of the first semantic grid map corresponding to the outside grid in the outside grid.

The determining of the representative label may comprise: determining a probability for a case in which the label of the grid is identical and a probability for a case in which the label of the grid is different, based on a per-label probability given to the grid of the first and second semantic grid maps and a label uncertainty probability computed by the per-label probability, computing, based on the probability for the case in which the label of the grid is different, the final probabilities of the label including uncertainty according to the probability for the case in which the label of the grid is identical and generating the fused grid map by determining the label corresponding to the highest value among the final probabilities as the representative label.

The mobility device may comprise: a memory configured to store at least one instruction, and a processor configured to execute the at least one instruction stored in the memory based on data obtained from the memory, wherein the processor may be further configured to: generate a first semantic grid map by using a segmentation model processing point cloud data and generating a second semantic grid map based on an object detection model, correct a probability regarding whether occupancy exists for an element included in each grid of the first and second semantic grid maps, and generate a fused grid map by determining, as a representative label, a label corresponding to a highest value among final probabilities of the label that are computed based on whether or not the label is identical for the element included in a grid of the first and second semantic grid maps.

The features of the present disclosure, which are briefly summarized herein, are only examples of examples of features of the present disclosure and detailed description of the disclosure which follows and are not intended to limit the scope of the present disclosure.

The technical problems solved by the present disclosure are not limited to the above mentioned technical problems. Other technical problems solved by the present disclosure, which are not described herein should be more clearly understood by a person having ordinary skill in the art of technical field to which the present disclosure belongs, from the following description.

According to the present disclosure, it is possible to provide a method for fusing grid maps obtained based on multi-sensors, which generates a grid map with reliability secured by fusing probabilities of respective grids from the grid maps including different information, and a mobility device using the method.

Also, it is possible to generate a grid map including semantic information that enables detection performance of an object to be improved and a non-standardized environmental object to be easily discriminated.

Also, it is possible to detect an environment safely and accurately by using a grid map with improved discrimination between a static object and a dynamic object and improved accuracy of objects classification and to improve the performance and reliability of an autonomous driving system.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative examples of the present disclosure. Examples or features described in the various examples may be applied independently or in combination of two or more.

In addition, various examples of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus for controlling autonomous driving of a vehicle, the method comprising:
generating, based on a segmentation model processing point cloud data, a first semantic grid map;
generating, based on an object detection model, a second semantic grid map;
adjusting a probability regarding whether occupancy exists for an element included in each grid of the first semantic grid map and the second semantic grid map; and
generating a fused grid map by determining, as a representative label, at least one label corresponding to a highest value among final probabilities of the at least one label, wherein the final probabilities are determined based on whether the at least one label matches the element;
outputting, based on the fused grid map, a signal; and
controlling, based on the signal, autonomous driving of the vehicle.

2. The method of claim 1, wherein the object detection model is an artificial intelligence (AI) model configured to perform an object detection task based on the segmentation model processing point cloud data and image data, and wherein the point cloud data and image data are generated based on at least one external object sensed by at least one sensor of the vehicle.

3. The method of claim 1, wherein the generating the first semantic grid map comprises:
transforming, based on a location of a sensor, at least one coordinate of a point cloud obtained from the sensor into at least one two-dimensional grid coordinate;
associating at least one or more of the at least one label with the at least one two-dimensional grid coordinate, wherein the at least one or more of the at least one label are obtained by a semantic segmentation model processing; and
determining, for each grid of the first semantic grid map, the probability and a per-label probability based on the associated at least one or more of the at least one label.

4. The method of claim 3, wherein the probability comprises an occupancy probability and a non-occupancy probability, wherein the occupancy probability is derived based on an occupancy reliability of each grid of the first semantic grid map, wherein the non-occupancy probability is based on a first uncertainty probability of each grid of the first semantic grid map, and wherein the first uncertainty probability is adjusted by an uncertainty factor.

5. The method of claim 4, wherein the per-label probability is generated to correspond to a specific label based on the first uncertainty probability and based on a ratio of a first number of first points in the at least one two-dimensional grid coordinate to a second number of second points in the at least one two-dimensional grid coordinate, wherein the specific label is added to the first points, and wherein the second points are included in each grid of the first semantic grid map.

6. The method of claim 1, wherein the generating the second semantic grid map comprises:
placing a bounding box produced by a sensor fusion object detection model on a predefined grid map;
designating an inner box and an outer box based on a predetermined deviation from the placed bounding box and generating a sample point in the outer box; and
determining, for each grid of the second semantic grid map, the probability based on the generated sample point and a per-label probability, wherein the per-label probability is based on a label of the bounding box, and wherein the bounding box is associated with the generated sample point.

7. The method of claim 6, wherein the probability comprises an occupancy probability and a non-occupancy probability, wherein the occupancy probability and the non-occupancy probability are based on an occupancy probability shape, and based on a preset second uncertainty probability associated with each grid of the second semantic grid map, and wherein the occupancy probability shape is changed based on a shape of an object indicated by the bounding box.

8. The method of claim 6, wherein the per-label probability is generated to correspond to the label of the bounding box based on a label uncertainty, wherein the label uncertainty is set based on performance of the sensor fusion object detection model.

9. The method of claim 6, wherein the adjusting the probability comprises:
reflecting a non-occupancy probability from a grid of the first semantic grid map into an occupancy probability of a corresponding grid in the second semantic grid map, wherein the corresponding grid in the second semantic grid map comprises at least a part of the placed bounding box;
assigning a second uncertainty probability to a grid outside the placed bounding box among the grid of the second semantic grid map; and
reflecting the probability from the grid of the first semantic grid map corresponding to the outside grid, into an occupancy probability of the outside grid in the second semantic grid map.

10. The method of claim 1, wherein the determining the at least one label comprises:
determining a probability for a case in which a label of a grid is identical and a probability for a case in which the label of the grid is different, based on a per-label probability assigned to each grid of the first semantic grid map and the second semantic grid map and based on a label uncertainty probability determined by the per-label probability; and
determining, based on the probability for the case in which the label of the grid is different, the final probabilities of the at least one label, wherein the final probabilities comprise uncertainty according to the probability for the case in which the label of the grid is identical.

11. An apparatus for controlling autonomous driving of a vehicle, the apparatus comprising:
a processor configured to execute at least one instruction;
a memory configured to store the at least one instruction that, when executed by the processor, is configured to cause the apparatus to
generate, based on a segmentation model processing point cloud data, a first semantic grid map;
generate, based on an object detection model, a second semantic grid map;
adjust a probability regarding whether occupancy exists for an element included in each grid of the first semantic grid map and the second semantic grid map;
generate a fused grid map by determining, as a representative label, at least one label corresponding to a highest value among final probabilities of the at least one label, wherein the final probabilities are determined based on whether the at least one label matches the element;
output, based on the fused grid map, a signal; and
control, based on the signal, autonomous driving of the vehicle.

12. The apparatus of claim 11, wherein the object detection model is an artificial intelligence (AI) model configured to perform an object detection task based on the segmentation model processing point cloud data and image data, and wherein the point cloud data and the image data are generated based on at least one external object sensed by at least one sensor of the vehicle.

13. The apparatus of claim 11, wherein the at least one instruction, when executed by the processor, is further configured to cause the apparatus to generate the first semantic grid map by:
transforming, based on a location of a sensor, a coordinate of a point cloud obtained from the sensor into at least one two-dimensional grid coordinate,
associating at least one or more of the at least one label with the at least one two-dimensional grid coordinate, wherein the at least one or more of the at least one label are obtained by a semantic segmentation model processing; and
determining, for each grid of the first semantic grid map, the probability and a per-label probability based on the associated at least one or more of the at least one label.

14. The apparatus of claim 13, wherein the probability comprises an occupancy probability and a non-occupancy probability, wherein the occupancy probability is derived based on an occupancy reliability of each grid of the first semantic grid map, wherein the non-occupancy probability is derived based on a first uncertainty probability of each grid of the first semantic grid map, and wherein the first uncertainty probability is adjusted by an uncertainty factor.

15. The apparatus of claim 14, wherein the per-label probability is generated to correspond to a specific label based on the first uncertainty probability and based on a ratio of a first number of first points in the at least one two-dimensional grid coordinate to a second number of second points in the at least one two-dimensional grid coordinate, wherein the specific label is added to the first points, and wherein the second points are included in each grid of the first semantic grid map.

16. The apparatus of claim 11, wherein the at least one instruction, when executed by the processor, is further configured to cause the apparatus to generate the second semantic grid map by:
placing a bounding box produced by a sensor fusion object detection model on a predefined grid map;
designating an inner box and an outer box based on a predetermined deviation from the placed bounding box and generating a sample point in the outer box; and
determining, for each grid of the second semantic grid map, the probability based on the generated sample point and a per-label probability, wherein the per-label probability is based on a label of the bounding box, and wherein the bounding box is associated with the generated sample point.

17. The apparatus of claim 16, wherein the probability comprises an occupancy probability and a non-occupancy probability, wherein that the occupancy probability and the non-occupancy probability are based on an occupancy probability shape and based on a preset second uncertainty probability associated with each grid of and the second semantic grid map, and wherein the occupancy probability shape is changed based on a shape of an object indicated by the bounding box.

18. The apparatus of claim 16, wherein the per-label probability is generated to correspond to the label of the bounding box based on a label uncertainty, wherein the label uncertainty is set based on performance of the sensor fusion object detection model.

19. The apparatus of claim 16, wherein the at least one instruction, when executed by the processor, is further configured to cause the apparatus to adjust the probability by:
reflecting a non-occupancy probability from a grid of the first semantic grid map into an occupancy probability of a corresponding grid in the second semantic grid map, wherein the corresponding grid in the second semantic grid map comprises at least a part of the placed bounding box,
assigning a second uncertainty probability to a grid outside the placed bounding box among the grid of the second semantic grid map, and
reflecting the probability from the grid of the first semantic grid map corresponding to the outside grid, into an occupancy probability of the outside grid in the second semantic grid map.

20. The apparatus of claim 11, wherein the at least one instruction, when executed by the processor, is further configured to cause the apparatus to:
determine a probability for a case in which a label of a grid is identical and a probability for a case in which the label of the grid is different, based on a per-label probability assigned to each grid of the first semantic grid map and the second semantic grid map and based on a label uncertainty probability determined by the per-label probability; and
determine, based on the probability for the case in which the label of the grid is different, the final probabilities of the at least one label, wherein the final probabilities comprise uncertainty according to the probability for the case in which the label of the grid is identical.
